(19) United States
(12) Patent Application Publication
(10) Pub. No.: US 2022/0099446 A1
(43) Pub. Date: Mar. 31, 2022

(54) OPERATION MANAGEMENT APPARATUS, OPERATION MANAGEMENT METHOD, OPERATION MANAGEMENT SYSTEM, AND VEHICLE

(71) Applicant: TOYOTA JIDOSHA KABUSHIKI KAISHA, Toyota-shi (JP)

(72) Inventors: Hiroshi HIGASHIDE, Nagoya-shi (JP); Keiichi UNO, Chita-gun (JP)

(73) Assignee: TOYOTA JIDOSHA KABUSHIKI KAISHA, Toyota-shi (JP)

(21) Appl. No.: 17/474,115

(22) Filed: Sep. 14, 2021

(30) Foreign Application Priority Data
Sep. 30, 2020 (JP) 2020-166551

(51) Int. Cl. G01C 21/34; B60W 60/00; G06Q 10/06; G06Q 50/26

(52) U.S. Cl. CPC G01C 21/3415; G01C 21/3461; B60W 60/001; B60W 2420/42; G06Q 50/26; G06Q 10/06313; G06Q 10/06312

(57) ABSTRACT

An operation management apparatus includes a controller. The controller outputs information that instructs a vehicle operated by automated driving about an operation schedule and an operation route. In a case in which the vehicle is being affected by a road obstruction that exists on the operation route, the controller acquires an image of the road obstruction from the vehicle. The controller automatically outputs an instruction to remove the road obstruction to a road management system based on the image of the road obstruction.

### CROSS-REFERENCE TO RELATED APPLICATION

This application claims priority to Japanese Patent Application No. 2020-166551 (filed on Sep. 30, 2020), the entire contents of which are incorporated herein by reference.

### TECHNICAL FIELD

The present disclosure relates to an operation management apparatus, an operation management method, an operation management system, and a vehicle.

### BACKGROUND

Systems for managing operations of route buses are known. For example, Patent Literature (PTL) 1 discloses an operation monitoring system that monitors a public bus and, upon occurrence of an error or delay, notifies an operator of the public bus of a response to be made to the situation so that the operator can respond immediately.

### CITATION LIST

### Patent Literature

PTL 1: JP H07-220192 A

### SUMMARY

Automated driving vehicles are sometimes unable to travel according to schedules due to a road obstruction that causes the automated driving vehicles to stop or get delayed. It is desirable to remove a road obstruction, so that automated driving vehicles can travel according to schedules even when the automated driving vehicles are unable to respond to the road obstruction by themselves.

It would be helpful to promptly remove a road obstruction.

An operation management apparatus according to an embodiment of the present disclosure includes a controller. The controller outputs information that instructs a vehicle operated by automated driving about an operation schedule and an operation route, and in a case in which the vehicle is being affected by a road obstruction that exists on the operation route, acquires an image of the road obstruction from the vehicle, and automatically outputs an instruction to remove the road obstruction to a road management system based on the image of the road obstruction.

An operation management system according to an embodiment of the present disclosure includes the operation management apparatus and the vehicle.

An operation management method according to an embodiment of the present disclosure includes outputting information that instructs a vehicle operated by automated driving about an operation schedule and an operation route, in a case in which the vehicle is being affected by a road obstruction that exists on the operation route, acquiring an image of the road obstruction from the vehicle, and automatically outputting an instruction to remove the road obstruction to a road management system based on the image of the road obstruction.

A vehicle according to an embodiment of the present disclosure is operated by automated driving. The vehicle includes a controller that controls operation of the vehicle based on information related to an operation schedule and an operation route generated by an operation management apparatus, and an imager that acquires an image of the vicinity of the vehicle. In a case in which the image of the vicinity of the vehicle includes an image of a road obstruction that exists on the operation route, the controller outputs the image of the road obstruction to the operation management apparatus.

According to the operation management apparatus, the operation management method, the operation management system, and the vehicle according to the embodiments of the present disclosure, a road obstruction can be promptly removed.

### BRIEF DESCRIPTION OF THE DRAWINGS

In the accompanying drawings:

FIG. 1 is a block diagram illustrating a configuration example of an operation management system according to an embodiment;

FIG. 2 illustrates an example of a road obstruction located on an operation route of a vehicle;

FIG. 3 illustrates an example of responsive work to the road obstruction that is performed by a road maintenance worker;

FIG. 4 is a flowchart illustrating an example procedure of an operation management method according to an embodiment; and

FIG. 5 is a flowchart illustrating an example procedure of a vehicle control method according to an embodiment.

### DETAILED DESCRIPTION

(Example Configuration of Operation Management System 1)

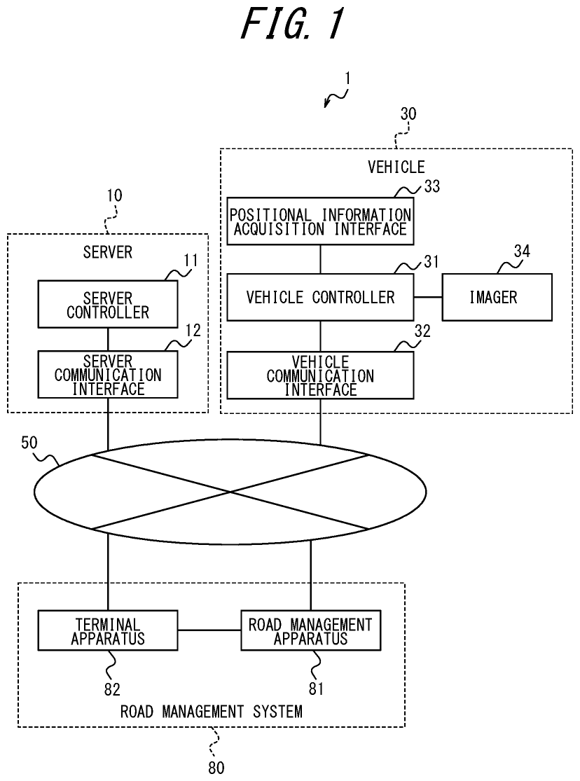

As illustrated in FIG. 1, an operation management system 1 according to an embodiment includes a server 10 and a vehicle 30. The server 10 and the vehicle 30 are connected to a network 50 and can communicate with each other. Each of the server 10 and the vehicle 30 is not limited to one and may be two or more in number.

The operation management system 1 provides a service for transporting a user by operating the vehicle 30 along a predetermined route. It is assumed that the vehicle 30 stops at a stop located on the predetermined route so as to allow the user to board. The predetermined route may include a circulating route or may include a route connecting two places.

The operation management system 1 is communicably connected to a road management system 80. The road management system 80 manages a road on which the vehicle 30 operates. The road management system 80 removes a road obstruction, such as a fallen object on a road, or damage to a road. An example configuration of the road management system 80 will be described later.

Hereinafter, an example configuration of the operation management system 1 for managing operation of the vehicle 30 will be described.

<Server 10>

The server 10 includes a server controller 11 and a server communication interface 12.

The server controller 11 controls the components of the server 10. The server controller 11 is also referred to simply as a controller. The server controller 11 may configured with one or more processors. The “processors” in the present embodiment may be, but are not limited to, general-purpose processors, or dedicated processors that are dedicated to specific processing. The server controller 11 may be configured with one or more dedicated circuits. Examples of dedicated circuits may include a Field-Programmable Gate Array (FPGA) and an Application Specific Integrated Circuit (ASIC). The server controller 11 may be configured with the dedicated circuits instead of the processors, or may be configured with the dedicated circuits along with the processors.

The server 10 may further include a memory. The memory may be, but is not limited to, a semiconductor memory, a magnetic memory, or an optical memory. The memory may function as, for example, a main memory, an auxiliary memory, or a cache memory. The memory may include an electromagnetic storage medium, such as a magnetic disc. The memory may include a non-transitory computer readable medium. The memory may store any information used for operations of the server 10. For example, the memory may store a system program, an application program, or the like. The memory may be included in the server controller 11.

The server communication interface 12 includes a communication module for communication with the vehicle 30 via the network 50. The server communication interface 12 is also referred to simply as a communication interface.

The server 10 may include a single server apparatus, or a plurality of server apparatuses capable of communicating with each other. The server 10 is also referred to as an operation management apparatus.

<Vehicle 30>

The vehicle 30 is, for example, a passenger transportation vehicle such as a bus, but not limited thereto, and may be any vehicle that can be used by a user as a passenger. The vehicle 30 is not limited to one and may be two or more in number. It is assumed that the vehicle 30 is operated by automated driving. The automated driving may be, for example, performed at any level from Level 1 to Level 5 as defined by the Society of Automotive Engineers (SAE). The automated driving may be performed based on other definitions without being limited to the exemplified definition.

The vehicle 30 includes a vehicle controller 31 and a vehicle communication interface 32. The vehicle controller 31 and the vehicle communication interface 32 are communicably connected to each other, for example, via an in-vehicle network, such as Controller Area Network (CAN), or a dedicated line.

The vehicle controller 31 controls the components included in the vehicle 30. The vehicle controller 31 is also referred to simply as a controller. The vehicle controller 31 may include one or more processors. The vehicle controller 31 may include one or more dedicated circuits instead of the processors, or may include one or more dedicated circuits along with the processors. The vehicle controller 31 may be configured further with a memory.

The vehicle communication interface 32 may include a communication module for communication with the server 10 via the network 50. The communication module may include, but is not limited to, a communication module compliant with a mobile communication standard, such as the 4th Generation (4G) standard or the 5th Generation (5G) standard. The vehicle communication interface 32 may be configured with, for example, an in-vehicle communication device. The vehicle communication interface 32 is also referred to simply as a communication interface.

The vehicle 30 further includes a positional information acquisition interface 33. The positional information acquisition interface 33 is communicably connected to the vehicle controller 31 or the vehicle communication interface 32 via an in-vehicle network, such as a CAN, or a dedicated line. The positional information acquisition interface 33 acquires positional information for the vehicle 30 itself. The positional information acquisition interface 33 may include a receiver compliant with a satellite positioning system. The receiver compliant with the satellite positioning system may include, for example, a Global Positioning System (GPS) receiver or the like. The vehicle 30 may output, to the server 10 through the vehicle communication interface 32, positional information for the vehicle 30 itself that is acquired by the positional information acquisition interface 33. The vehicle controller 31 controls automated driving based on positional information for the vehicle 30.

The vehicle 30 further includes an imager 34. The imager 34 captures an image of the vicinity of the vehicle 30. The vicinity of the vehicle 30 includes a road surface on which the vehicle 30 is travelling. The vicinity of the vehicle 30 includes a person or an object that exists in the vicinity of the vehicle 30. The imager 34 may include an imaging device to image visible light, or an imaging device to image electromagnetic waves other than visible light, such as infrared light. The imager 34 outputs a captured image to the vehicle controller 31. The vehicle controller 31 outputs the captured image to the server 10.

(Example Configuration of Road Management System 80)

The road management system 80 includes a road management apparatus 81 and a terminal apparatus 82.

The road management apparatus 81 processes information for managing a road. The information for managing the road is also referred to as road management information. The road management information includes, for example, information related to an obstacle fallen on the road. The road management information includes information related to damage to a road surface, such as a hole in the road or a step on the road. The road management apparatus 81 may be configured to be identical or similar to the server 10.

The terminal apparatus 82 is in the possession of a road maintenance worker and is configured to be able to notify the road maintenance worker of road control information. The terminal apparatus 82 may include, for example, a mobile terminal, such as a smartphone. The terminal apparatus 82 may include a PC, such as a notebook Personal Computer (PC) or a tablet PC. The terminal apparatus 82 is not limited to the above examples and may include various devices.

The terminal apparatus 82 may include a controller configured with a processor or the like. The terminal apparatus 82 may include a memory. The terminal apparatus 82 may include a communication interface configured with a communication module for communication with the server 10 via the network 50. The communication module may include, but is not limited to, a communication module compliant with a mobile communication standard, such as the 4th Generation (4G) standard or the 5th Generation (5G) standard.

The terminal apparatus 82 may include an input interface configured with an input device for receiving inputs from a user. The input device may be configured with, for example, a touch panel, a touch sensor, or a pointing device such as a mouse. The input device may be configured with a physical key. The input device may be configured with an audio input device, such as a microphone.

The terminal apparatus 82 may include an output interface configured with an output device for outputting information to cause the user to recognize the information. The output device may include, for example, a display device that outputs visual information, such as images, letters, or graphics. The display device includes, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED). The display device may be configured with various other devices. The output device may include, for example, an audio output device, such as a speaker, that outputs audio information, such as voice. The output device is not limited to the above examples and may include various other devices.

(Example Operation of Operation Management System 1 and Road Management System 80)

The server controller 11 of the server 10 processes information related to a vehicle 30 operated by automated driving and manages an operation schedule of the vehicle 30. The operation schedule includes information that identifies a target position at a predetermined time for the vehicle 30. The server controller 11 acquires positional information for the vehicle 30 or information on the vicinity of the vehicle 30 as the information related to the vehicle 30, and outputs information that instructs the vehicle 30 to operate, so that the vehicle 30 can arrive at a predetermined place at a predetermined time. That is, the server controller 11 processes information that is acquired from the vehicle 30 and information that is outputted to the vehicle 30.

The server controller 11 generates information that instructs the vehicle 30 about an operation schedule and an operation route. The operation route includes a route along which the vehicle 30 is to travel for transportation of a passenger. The operation route may include a position of a stop for the vehicle 30 to allow boarding and alighting of a passenger. The operation schedule includes a time at which the vehicle 30 is to arrive at a predetermined place included in the operation route, or a time at which the vehicle 30 is to depart from the predetermined place.

<Imaging of Road Obstruction>

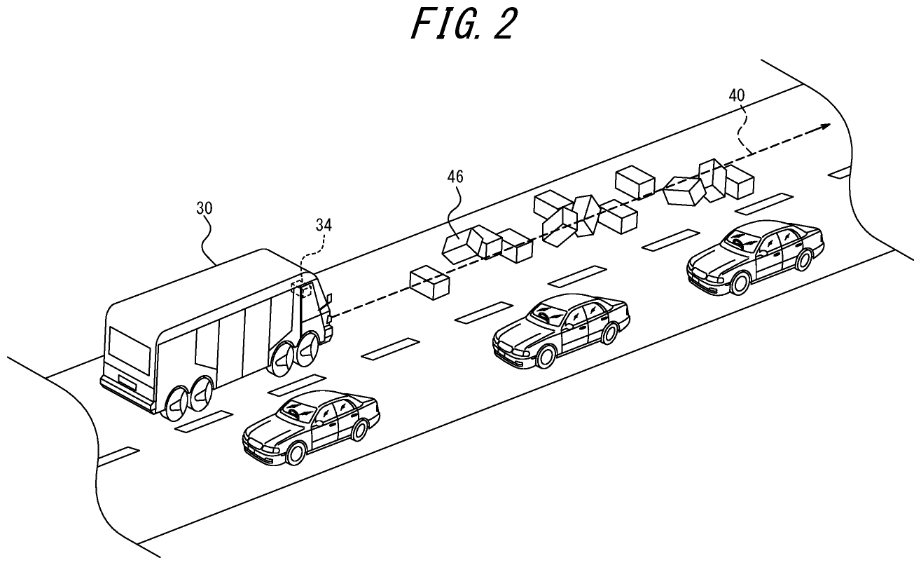

When traveling along an operating route, a vehicle 30 may be affected by a road obstruction that exists on the operation route. For example, as illustrated in FIG. 2, a fallen object 46 on a road may exist as a road obstruction on a route 40 along which the vehicle 30 travels.

The vehicle 30 can decelerate or stop due to a road obstruction. Further, the vehicle 30 can travel by bypassing the road obstruction within a range that does not deviate from the operation route or through a bypass route that is presumed in advance. The vehicle 30 is sometimes not able to arrive at a predetermined place or not able to depart from the predetermined place at a time defined by an operation schedule due to deceleration, stopping, or bypassing. In other words, the vehicle 30 may run behind the operation schedule by being affected by the road obstruction.

The imager 34 of the vehicle 30 captures an image of a road obstruction in a case in which the road obstruction exists on the operation route or it is affected by the road obstruction. The captured image of the road obstruction is also referred to as a road obstruction image. In the example of FIG. 2, the imager 34 outputs a road obstruction image including the fallen object 46 on the road as a road obstruction. The imager 34 outputs the road obstruction image to the vehicle controller 31. The vehicle controller 31 outputs the road obstruction image to the server 10. The vehicle controller 31 outputs, to the server 10, positional information for the vehicle 30, together with the road obstruction image.

<Response to Road Obstruction>

The server controller 11 acquires a road obstruction image from a vehicle 30. The server controller 11 may further acquire positional information for the vehicle 30. Based on the road obstruction image, the server controller 11 generates information indicating an instruction to remove the road obstruction and outputs the information to the road management system 80. The information indicating the instruction to remove the road obstruction is also referred to as removal instruction information. The server controller 11 may generate removal instruction information further based on positional information for the vehicle 30 and output the information to the road management system 80. The server controller 11 may automatically output removal instruction information to the road management system 80. Automatic output of removal instruction information to the road management system 80 omits the process, performed by the operation management system 1, of determining whether to instruct that the road obstruction be removed. This reduces workload of a person in charge in the operation management system 1. Further, ability requirements for a person in charge in the operation management system 1 are reduced. Consequently, the staffing of a person in charge in the operation management system 1 is easier.

The server controller 11 outputs removal instruction information to the road management apparatus 81 and/or the terminal apparatus 82 included in the road management system 80. Upon acquiring the removal instruction information, the road management apparatus 81 may determine the number of road maintenance workers, or a tool, a part, or the like that is required to remove a road obstruction based on the removal instruction information. The road management apparatus 81 assigns a road maintenance worker to perform removal work of the road obstruction. The road management apparatus 81 may estimate the amount of time required to complete removal of the road obstruction and produces an output to the server 10.

The road management apparatus 81 may determine a worker, or equipment or materials required to remove a road obstruction, based on a database storing information associating the contents of road obstructions in the past with the contents of work performed to remove the road obstructions.

The road management apparatus 81 may estimate the amount of time required to complete removal of a road obstruction, based on a database storing information associating the contents of road obstructions in the past with the amounts of time spent to complete removal of the road obstructions.

Upon acquiring removal instruction information, the terminal apparatus 82 notifies a road maintenance worker in the possession of the terminal apparatus 82 of the removal instruction information. The terminal apparatus 82 prompts the road maintenance worker to input a determination result indicating whether the road maintenance worker can undertake removal work of the road obstruction specified by the removal instruction information, and produces an output to the server 10 or to the road management apparatus 81. In a case in which the road maintenance worker can undertake the removal work of the road obstruction, the terminal apparatus 82 may prompt input of an estimated amount of time required to complete removal of the road obstruction and output it to the server 10 or to the road management apparatus 81.

The server controller 11 may acquire an estimated amount of time required to complete removal of a road obstruction from the road management apparatus 81 or the terminal apparatus 82 included in the road management system 80. The estimated amount of time required to complete the removal of the road obstruction is also referred to as an estimated amount of time for road obstruction removal.

The server controller 11 may estimate the amount of time required to complete removal of a road obstruction by the server controller 11 itself based on a road obstruction image. In other words, the server controller 11 may acquire an estimated amount of time for road obstruction removal by the server controller 11 itself. Specifically, the server controller 11 may perform a method that is same as or similar to that for the road management apparatus 81 to acquire an estimated amount of time for road obstruction removal. The server 10 may store, in a memory, a database related to the contents of road obstructions.

Based on an estimated amount of time for road obstruction removal, the server controller 11 may change the operation schedule of the vehicle 30 on the operation route that is being affected by the road obstruction. For example, the server controller 11 may estimate the amount of delay time of the vehicle 30 that will arise due to deceleration of the vehicle 30 affected by the road obstruction, to thereby change the operation schedule of the vehicle 30. In a case in which the road obstruction results in an impassable section for the vehicle 30, the server controller 11 may estimate the amount of delay time that will arise due to the vehicle 30 bypassing the section, to thereby change the operation schedule of the vehicle 30.

By changing the operation schedule of the vehicle 30 based on occurrence of a road obstruction, the operation management system 1 can inform a passenger of the vehicle 30 of a time of arrival at a destination. Further, the operation management system 1 can inform a passenger who will board the vehicle 30 of a time at which the vehicle 30 will arrive at a stop. Consequently, convenience for a passenger is improved.

Based on an estimated amount of time for road obstruction removal, the server controller 11 may generate information indicating an instruction to add another vehicle 30 to operate on the operation route that is being affected by the road obstruction.

<Removal Work of Road Obstruction>

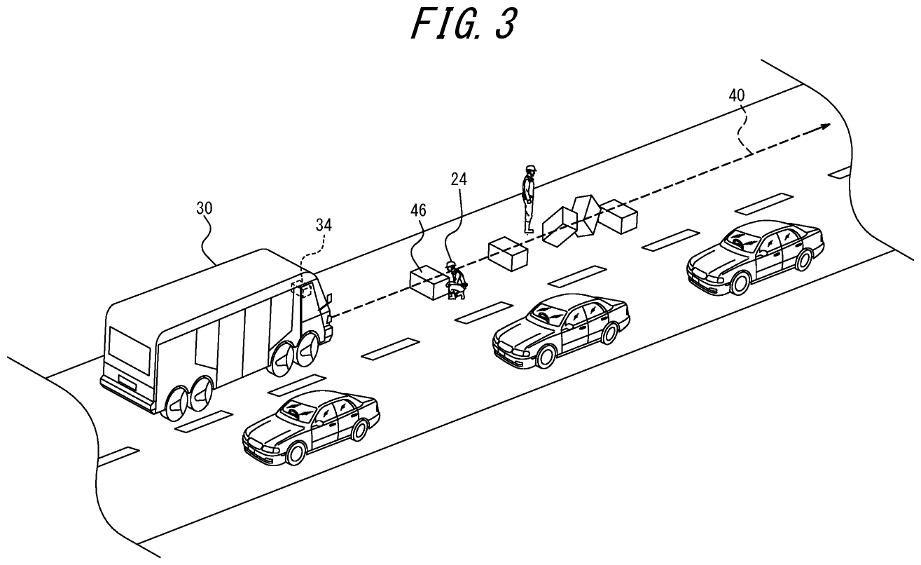

Based on removal instruction information notified from the terminal apparatus 82, a road maintenance worker who belongs to the road management system 80 travels to a place of occurrence of a road obstruction and performs work to remove the road obstruction. For example, in a case in which the fallen object 46 on the road exists as a road obstruction, a fallen object collection worker 24 as a road maintenance worker may remove the road obstruction by collecting the fallen object 46 on the road as illustrated in FIG. 3. For example, in a case in which there is damage to a road surface, such as a hole or a step, as a road obstruction, a road maintenance worker may remove the road obstruction by repairing the damage. Upon completion of removal of the road obstruction, the road maintenance worker inputs a completion report to the terminal apparatus 82.

<Response after Completion of Removal of Road Obstruction>

The road management system 80 outputs, to the server 10, a report that removal of a road obstruction is completed as a result of work or the like by a road maintenance worker. Specifically, the terminal apparatus 82 may accept an input from the road maintenance worker for a completion report for removal work and output the completion report to the road management apparatus 81 or to the server 10. Alternatively, the road management apparatus 81 may acquire the completion report for the removal work from the terminal apparatus 82 and output it to the server 10.

The server controller 11 acquires, from the road management system 80, a report that removal of a road obstruction is completed. The server controller 11 changes an operation schedule of a vehicle 30 on an operation route affected by the road obstruction. For example, the server controller 11 may change the operation schedule to the one that allows the vehicle 30 to travel faster so as to make up for a delay due to the effect of the road obstruction. The server controller 11 may change the operation schedule to the one by which another vehicle 30 is added to operate on the operation route affected by the road obstruction so as to make up for a reduction in the number of transported persons due to the effect of the road obstruction. Once the delay or the reduction in the number of transported persons due to the effect of the road obstruction is made up for, the server controller 11 may change the operation schedule to a previous operation schedule before occurrence of the road obstruction.

By changing an operation schedule of the vehicle 30 based on removal of a road obstruction, the operation management system 1 is able to inform a passenger of the vehicle 30 of a time of arrival at a destination. Further, the operation management system 1 can inform a passenger who will board the vehicle 30 of a time at which the vehicle 30 will arrive at a stop. Consequently, convenience for a passenger is improved.

Upon detecting that a road obstruction has been removed, the vehicle controller 31 of the vehicle 30 may cause the vehicle 30 to travel by normal automated driving. For example, in a case in which the vehicle 30 remains stationary due to the road obstruction, the vehicle controller 31 may cause the vehicle 30 to resume autonomous driving upon detecting that the road obstruction has been removed. In a case in which the vehicle 30 is decelerated due to the road obstruction, the vehicle controller 31 may revert the speed of the vehicle 30 to its normal speed upon detecting that the road obstruction has been removed. Based on a completion report for the road obstruction, the server controller 11 may output an instruction for the vehicle 30 to resume operation. The vehicle controller 31 may resume operation of the vehicle 30 upon receiving the instruction to resume operation from the server 10.

As described above, the operation management system 1 according to the present embodiment can determine the status of a road obstruction based on an image of the road obstruction. Even when operation of the vehicle 30 is affected by the road obstruction, the operation management system 1 can make a determination or instruction so that the number of passengers transported by the vehicle 30 or the transportation speed will be maintained. Consequently, convenience for a passenger who uses the vehicle 30 is improved.

Further, the operation management system 1 according to the present embodiment automatically instructs the road management system 80 to remove a road obstruction. Since the operation management system 1 automatically instructs that the road obstruction be removed, a prompt response to the road obstruction is possible. The prompt response reduces the amount of time to complete removal of the road obstruction. By reducing the amount of time to complete removal of the road obstruction, the number of passengers transported by the vehicle 30 or the transportation speed are more likely to be maintained. Consequently, convenience for a passenger who uses the vehicle 30 is improved.

Further, since the operation management system 1 automatically instructs that a road obstruction be removed, determination ability requirements for a person in charge of operating the operation management system 1 can be reduced. Reducing the ability requirements for a person in charge can reduce workload for the person in charge. Further, recruitment of a person in charge can be easier. Moreover, operation of the vehicle 30 can be continued even during a time of day when it is difficult to retain a worker, such as late at night or early in the morning.

The operation management system 1 changes an operation schedule of the vehicle 30 based on an estimated amount of time for road obstruction removal. Thus, even when operation of the vehicle 30 is affected by the road obstruction, the number of passengers transported by the vehicle 30 or the transportation speed can be maintained.

(Example of Operation Management Method)

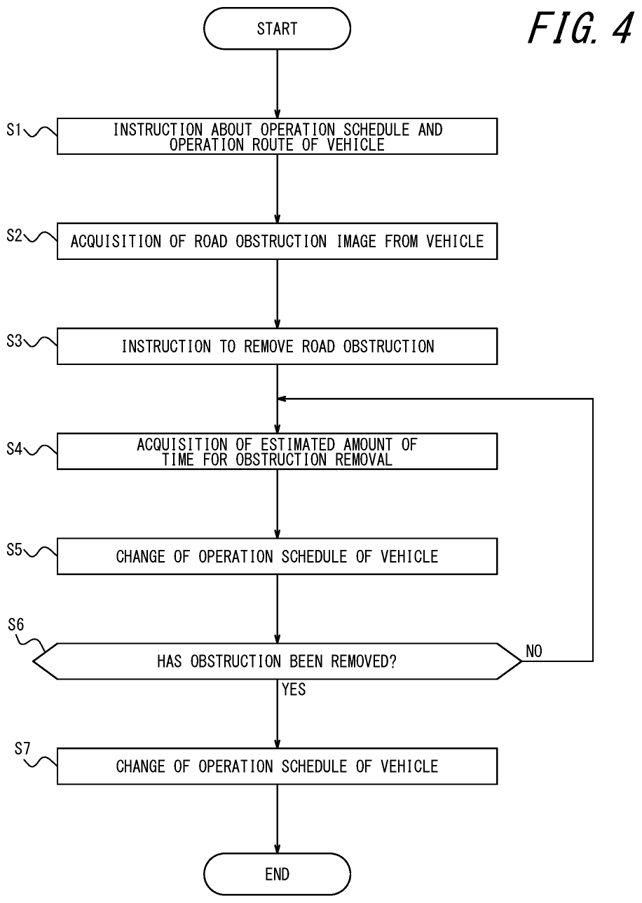

The server controller 11 may perform an operation management method including a procedure shown in the flowchart illustrated in FIG. 4. The operation management method may be implemented as an operation management program to be executed by the processors constituting the server controller 11. The operation management program may be stored on a non-transitory computer readable medium.

The server controller 11 generates an operation schedule and an operation route of a vehicle 30 and instructs the vehicle 30 (Step S1).

The server controller 11 acquires a road obstruction image from the vehicle 30 (Step S2).

The server controller 11 generates and outputs information indicating an instruction to remove a road obstruction to the road management system 80 (Step S3).

The server controller 11 acquires an estimated amount of time for road obstruction removal (Step S4).

The server controller 11 changes the operation schedule of the vehicle 30 based on the estimated amount of time for road obstruction removal (Step S5). The server controller 11 may output an instruction to add another vehicle 30 to the operation route that is being affected by the road obstruction, as needed.

The server controller 11 determines whether the road obstruction has been removed (Step S6). The server controller 11 may execute the determination of Step S6 after the estimated amount of time for the road obstruction removal. The server controller 11 may execute the determination of Step S6 regardless of the estimated amount of time for the road obstruction removal.

In a case in which the road obstruction has not been removed (Step S6: NO), the server controller 11 may return to the procedure of Step S4 and acquire an estimated amount of time for road obstruction removal again. The server controller 11 may simply repeat the procedure of Step S6.

In a case in which the road obstruction has been removed (Step S6: YES), the server controller 11 changes the operation schedule of the vehicle 30 (Step S7). After executing the procedure of Step S7, the server controller 11 ends the execution of the procedure shown in the flowchart of FIG. 4.

As described above, according to the operation management method of the present embodiment, by determining the status of a road obstruction based on an image of the road obstruction, a determination or instruction can be made so that the number of transported passengers or a transportation speed can be maintained even when under the effect of the road obstruction. Consequently, convenience for a passenger who uses the vehicle 30 is improved.

Further, according to the operation management method of the present embodiment, the road management system 80 is automatically instructed to remove a road obstruction. The automatic instruction to remove the road obstruction enables a prompt response to the road obstruction. The prompt response reduces the amount of time to complete removal of the road obstruction. By reducing the amount of time to complete removal of the road obstruction, the number of passengers transported by the vehicle 30 or the transportation speed are more likely to be maintained. Consequently, convenience for a passenger who uses the vehicle 30 is improved.

Further, due to an automatic instruction to remove a road instruction, determination ability requirements for a person in charge of managing operation of the vehicle 30 can be reduced. Reducing the ability requirements for a person in charge can reduce workload for the person in charge. Further, recruitment of a person in charge can be easier. Moreover, operation of the vehicle 30 can be continued even during a time of day when it is difficult to retain a worker, such as late at night or early in the morning.

According to the operation management method of the present embodiment, an operation schedule of the vehicle 30 is changed based on an estimated amount of time for road obstruction removal. Thus, even when operation of the vehicle 30 is affected by the road obstruction, the number of passengers transported by the vehicle 30 or the transportation speed can be maintained. Consequently, convenience for a passenger who uses the vehicle 30 is improved.

(Example of Vehicle Control Method)

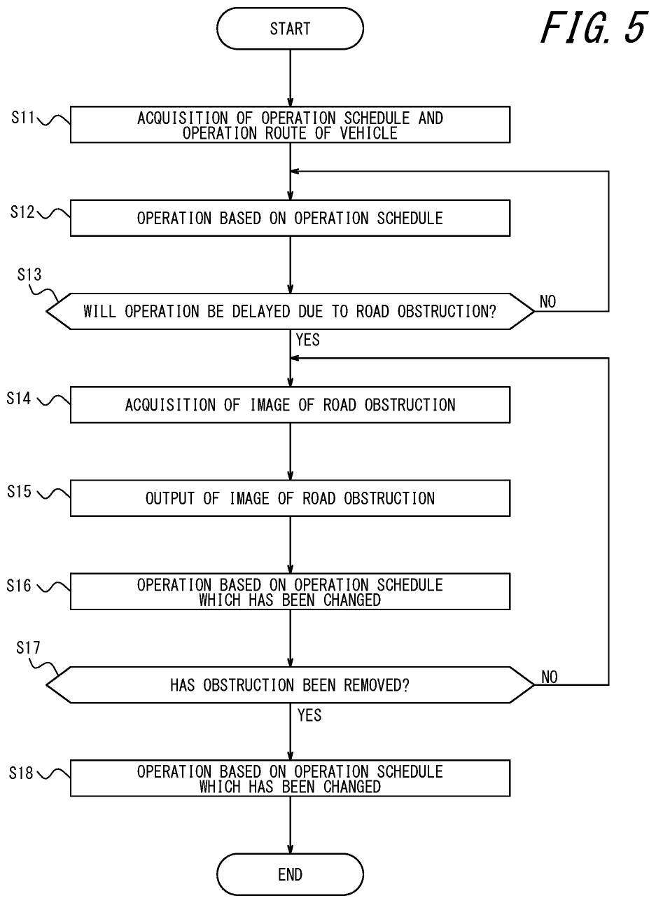

The vehicle controller 31 may perform a vehicle control method including a procedure shown in the flowchart illustrated in FIG. 5. The vehicle control method may be implemented as a vehicle control program to be executed by the processors constituting the vehicle controller 31.

The vehicle controller 31 acquires an operation schedule and an operation route of the vehicle 30 (Step S11).

The vehicle controller 31 causes the vehicle 30 to operate based on the operation schedule (Step S12).

The vehicle controller 31 determines whether operation of the vehicle 30 will be delayed due to a road obstruction (Step S13). In a case in which the operation of the vehicle 30 will not be delayed due to the road obstruction (Step S13: NO), the vehicle controller 31 returns to Step S12 and continues the operation of the vehicle 30.

In a case in which the operation of the vehicle 30 will be delayed due to the road obstruction (Step S13: YES), the vehicle controller 31 acquires a road obstruction image by the imager 34 (Step S14).

The vehicle controller 31 outputs the road obstruction image to the server 10 (Step S15).

The vehicle controller 31 operates the vehicle 30 based on an operation schedule which has been changed by the server 10 in accordance with the effect of the road obstruction (Step S16).

The vehicle controller 31 determines whether the road obstruction has been removed (Step S17). In a case in which the road obstruction has been not removed (Step S17: NO), the vehicle controller 31 may return to Step S14 and acquire a road obstruction image. The vehicle controller 31 may continue operation of the vehicle 30 based on an operation schedule which has been changed in accordance with the status of the road obstruction.

In a case in which the road obstruction has been removed (Step S17: YES), the vehicle controller 31 operates the vehicle 30 based on an operation schedule which has been changed by the server 10 in accordance removal of the road obstruction (Step S18). After execution of the procedure of Step S18, the vehicle controller 31 ends the execution of the procedure shown in the flowchart of FIG. 5.

As described above, according to the vehicle control method of the present embodiment, the vehicle 30 can operate based on an operation schedule which has been changed in accordance with the status of a road obstruction. Thus, even when operation of the vehicle 30 is affected by the road obstruction, the number of passengers transported by the vehicle 30 and the transportation speed can be maintained. Consequently, convenience for a passenger who uses the vehicle 30 is improved.

### Other Embodiments

<Example Related to Road Obstruction and Removal Thereof>

A road obstruction may include an obstruction that blocks operation of a vehicle 30. The obstruction may include, for example, a scattered object such as garbage, a stationary vehicle or a vehicle involved in an accident, or the like. A road obstruction may include damage to a road surface on which a vehicle 30 operates. The damage to the road surface may include, for example, a pit on the road surface, cracking on the road surface, a step on the road surface, or the like. A road obstruction may include, for example, various other modes of obstructions, such as a flooded road.

In the embodiment described above, the server 10 or the road management apparatus 81 analyzes the content of a road obstruction and determines a response based on the content of the road obstruction. The vehicle controller 31 or the imager 34 of a vehicle 30 may analyze the content of a road obstruction based on a road obstruction image and output an analysis result, together with the road obstruction image, to the server 10. The vehicle controller 31 may control operation of the vehicle 30 based on the analysis result of the content of the road obstruction.

When generating removal instruction information based on a road obstruction image, the server controller 11 of the server 10 may determine a worker, or equipment or materials required to remove the road obstruction and produce an output, together with the removal instruction information, to the road management system 80. The server controller 11 may determine the required worker, or equipment or materials based on a database storing information associating the contents of road obstructions in the past with the contents of work performed to remove the road obstructions.

The server 10 or the road management apparatus 81 may determine the required worker, or equipment or materials based on a database storing information associating places of occurrence of road obstructions with the contents of work performed to remove the road obstructions or with the amounts of time spent to remove the road obstructions, and may estimate the amount of time required to complete removal of the road obstruction.

In a case in which a road obstruction that has occurred is not included in patterns registered in a database, the server 10 or the road management apparatus 81 may generate an instruction to dispatch a road maintenance worker to the actual place for investigation and output the instruction to the terminal apparatus 82. The terminal apparatus 82 may prompt the road maintenance worker to input an investigation result of the road obstruction to be outputted to the server 10 or to the road management apparatus 81. Based on the investigation result, the server 10 or the road management apparatus 81 may determine a required worker, or equipment or materials or may estimate the amount of time required to complete removal of the road obstruction. The terminal apparatus 82 may prompt the road maintenance worker to input the required worker, or equipment or materials or to input an estimated amount of time required to complete the removal of the road obstruction.

The road management system 80 prepares and executes removal work of a road obstruction based on removal instruction information acquired from the server controller 11. A road maintenance worker travels to a place at which the road obstruction exists based on the removal instruction information notified by the terminal apparatus 82. The road maintenance worker may check the state of the road obstruction at the actual place and correct the content of work instructed by the removal instruction information as needed.

An estimated amount of time for road obstruction removal may include the amount of time it takes for a road maintenance worker to travel to the actual place. The estimated amount of time for road obstruction removal may include the amount of time it takes for a road maintenance worker to investigate the content of the road obstruction at the actual place. The estimated amount of time for road obstruction removal may be indicated as a scheduled time for the road obstruction to be removed. The estimated amount of time for the road obstruction removal or the scheduled time for removal may be sequentially updated based on the progress of removal work of the road obstruction. That is, the server controller 11 may acquire the progress of the removal work of the road obstruction performed by a road maintenance worker from the terminal apparatus 82, and sequentially update the estimated amount of time for road obstruction removal or the scheduled time for removal.

<Example of Passenger Response>

The server controller 11 may output to a vehicle 30 an estimated amount of time for road obstruction removal or a scheduled time for removal which has been updated, to thereby to notify a passenger, or may output it to a stop, to thereby notify a passenger waiting for the vehicle 30.

The vehicle controller 31 may notify a passenger of the estimated amount of time for road obstruction removal or the scheduled time for removal that has been acquired from the server 10. In a case in which the estimated amount of time for road obstruction removal that has been acquired from the server 10 is longer than a predetermined time period or in which the scheduled time for removal is later than a predetermined time, the vehicle controller 31 may open a door of the vehicle 30 so that the passenger can give up resuming operation of the vehicle 30 and alight.

In a case in which there is a vehicle 30 that is not able to resume operation until a road obstruction is removed, the server controller 11 may generate an instruction to add another vehicle 30 to which a passenger can transit. The server controller 11 may generate information that proposes a bypass route for the passenger who has alighted from the vehicle 30, and may output the information to the vehicle 30. The server controller 11 may generate information that proposes an alternative way so that the passenger can alight from the vehicle 30 and travel by another transportation means, and may output the information to the vehicle 30. The server controller 11 may determine information to be proposed to the passenger based on the estimated amount of time for road obstruction removal or the scheduled time for removal.

<Operational Design Domain of Vehicle 30>

In a case in which a road obstruction exists on an operation route of a vehicle 30, the vehicle controller 31 may determine that the state of the vehicle 30 is outside the Operational Design Domain (ODD). The operational design domain corresponds to conditions that the situation surrounding the vehicle 30 is to satisfy to enable the vehicle 30 to operate autonomously. For example, in a case in which there is a road obstruction that blocks operation of the vehicle 30, the state of the vehicle 30 may be outside the operational design domain. Further, in a case in which there is a road obstruction on the operation route of the vehicle 30 and in which the vehicle 30 is not able to operate by bypassing the road obstruction, the state of the vehicle 30 may be outside the operational design domain. The vehicle controller 31 may determine whether the state of the vehicle 30 is within the operational design domain or outside the operational design domain based on an image captured by the imager 34. Upon determining that the state of the vehicle 30 is outside the operational design domain, the vehicle controller 31 may output the image captured by the imager 34 as a road obstruction image to the server 10. The vehicle controller 31 may control the vehicle 30 so that the state of the vehicle 30 continuously falls within the operational design domain. Upon determining that the state of the vehicle 30 is outside the operational design domain, the vehicle controller 31 may analyze the existence of the road obstruction from the image captured by the imager 34.

<Example of System Configuration>

In the above embodiments, a configuration in which the single operation management system 1 and the single road management system 80 are connected to each other has been described. The operation management system 1 and/or the road management system 80 may be plural in number. That is, a plurality of operation management systems 1 and a single road management system 80 may be connected to each other. A single operation management system 1 and a plurality of road management systems 80 may be connected to each other. A plurality of operation management systems 1 and a plurality of road management systems 80 may be connected to each other.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An operation management apparatus comprising
a controller, wherein
the controller is configured to:
output information that instructs a vehicle configured to be operated by automated driving about an operation schedule and an operation route;
in a case in which the vehicle is being affected by a road obstruction that exists on the operation route, acquire an image of the road obstruction from the vehicle; and
automatically output an instruction to remove the road obstruction to a road management system based on the image of the road obstruction.

2. The operation management apparatus according to claim 1, wherein
the controller is configured to acquire an estimated amount of time required to remove the road obstruction from the road management system and to change the operation schedule of the vehicle based on the estimated amount of time.

3. The operation management apparatus according to claim 2, wherein
the controller is configured to generate an instruction to add another vehicle to the operation route that is being affected by the road obstruction, based on the estimated amount of time.

4. The operation management apparatus according to claim 1, wherein
the controller, upon acquiring from the road management system a report that the road obstruction has been removed, changes the operation schedule of the vehicle.

5. The operation management apparatus according to claim 1, wherein
the controller is configured to automatically output an instruction to remove the road obstruction to a terminal apparatus included in the road management system.

6. The operation management apparatus according to claim 1, wherein
the controller acquires the image of the road obstruction from the vehicle when the vehicle is affected by the road obstruction.

7. An operation management system comprising:
the operation management apparatus according to claim 1; and
the vehicle.

8. An operation management method, comprising:
outputting information that instructs a vehicle configured to be operated by automated driving about an operation schedule and an operation route;
in a case in which the vehicle is being affected by a road obstruction that exists on the operation route, acquiring an image of the road obstruction from the vehicle; and
automatically outputting an instruction to remove the road obstruction to a road management system based on the image of the road obstruction.

9. The operation management method according to claim 8, further comprising:
acquiring an estimated amount of time required to remove the road obstruction from the road management system; and
changing the operation schedule of the vehicle based on the estimated amount of time.

10. The operation management method according to claim 9, further comprising
generating an instruction to add another vehicle to the operation route that is being affected by the road obstruction, based on the estimated amount of time.

11. The operation management method according to claim 8, further comprising
upon acquiring from the road management system a report that the road obstruction has been removed, changing the operation schedule of the vehicle.

12. The operation management method according to claim 8, further comprising
automatically outputting an instruction to remove the road obstruction to a terminal apparatus included in the road management system.

13. The operation management method according to claim 8, further comprising
acquiring the image of the road obstruction from the vehicle when the vehicle is affected by the road obstruction.

14. A vehicle configured to be operated by automated driving, the vehicle comprising:
a controller configured to control operation of the vehicle based on information related to an operation schedule and an operation route generated by an operation management apparatus; and
an imager configured to acquire an image of the vicinity of the vehicle, wherein
in a case in which the image of the vicinity of the vehicle includes an image of a road obstruction that exists on the operation route, the controller outputs the image of the road obstruction to the operation management apparatus.

15. The vehicle according to claim 14, wherein
the controller is configured to control the operation of the vehicle further based on the image of the road obstruction.

16. The vehicle according to claim 14, wherein
the controller is configured to acquire, from the operation management apparatus, information that the road obstruction has been removed.

17. The vehicle according to claim 14, wherein
the controller is configured to determine whether the road obstruction has been removed based on the image of the vicinity of the vehicle.

18. The vehicle according to claim 14, wherein
the controller is configured to acquire from the operation management apparatus an operation schedule that has been changed based on the image of the road obstruction and to control the operation of the vehicle.

19. The vehicle according to claim 14, wherein
the controller is configured to determine whether a state of the vehicle is within an operational design domain or outside the operational design domain based on the image acquired by the imager.

20. The vehicle according to claim 19, wherein
the controller, upon determining that the state of the vehicle is outside the operational design domain, outputs the image acquired by the imager as an image of the road obstruction to the operation management apparatus.
